(19) United States
(12) Patent Application Publication
(10) Pub. No.: US 2020/0114842 A1
(43) Pub. Date: Apr. 16, 2020

(54) VEHICLE CLOSURE OPEN WARNING SYSTEM AND METHOD

(71) Applicant: GM GLOBAL TECHNOLOGY OPERATIONS LLC, Detroit, MI (US)

(72) Inventors: James N. Nelsen, Howell, MI (US); Scott A. Niemiec, West Bloomfield, MI (US); Reuben E. Coelho, Sterling Heights, MI (US)

(73) Assignee: GM GLOBAL TECHNOLOGY OPERATIONS LLC, Detroit, MI (US)

(21) Appl. No.: 16/160,076

(22) Filed: Oct. 15, 2018

(51) Int. Cl. B60R 16/023; B60R 21/01; B60W 40/12; B60W 50/00

(52) U.S. Cl. CPC B60R 16/0232; B60R 21/01; B60W 40/12; B60W 2720/10; B60R 2021/01006; B60W 2400/00; B60W 50/0098

(57) ABSTRACT

In an exemplary embodiment, a vehicle is provided that includes a body, a propulsion system, a hood, a sensor, and a processor. The propulsion system is configured to generate movement of the body. The sensor is disposed onboard the vehicle and configured to provide sensor data pertaining to one or more components of the vehicle. The processor is disposed onboard the vehicle, coupled to the sensor, and is configured to: determine whether the hood is closed via a latching mechanism, using the sensor data; and provide instructions to a drive system of the vehicle, to take a control action to adjust movement of the vehicle when it is determined that the hood of the vehicle is not closed via the latching mechanism.

### TECHNICAL FIELD

The technical field generally relates to vehicles and, more specifically, to methods and systems for controlling vehicle movement when a closure (e.g., a hood) of the vehicle may not be properly closed.

### BACKGROUND

Many vehicles include a hood that secures to a vehicle via hood latching mechanisms. Many vehicles also include other closures (e.g. for the rear or one or more sides of the vehicle). However, in certain situations the hood or other closure of the vehicle may not be properly closed via the latching mechanism. It may be desirable, in certain situations, to provide appropriate actions when a determination is made that the hood or other closure is not properly closed.

Accordingly, it is desirable to provide improved methods and systems for providing appropriate actions when a determination is made that a vehicle hood or other closure is not properly closed. Furthermore, other desirable features and characteristics of the present invention will become apparent from the subsequent detailed description of the invention and the appended claims, taken in conjunction with the accompanying drawings and this background of the invention.

### SUMMARY

In one embodiment, a method is disclosed. The method includes: obtaining sensor data via one or more sensors of a vehicle; determining whether a closure of the vehicle is closed via a latching mechanism, using the sensor data; and taking a control action, based on instructions provided by a processor of the vehicle to a drive system of the vehicle, to adjust movement of the vehicle when it is determined that the closure of the vehicle is not closed via the latching mechanism.

Also in one embodiment, the step of taking the control action includes preventing the vehicle from shifting out of a park gear, when it is determined that the closure of the vehicle is not closed via the latching mechanism.

Also in one embodiment, the step of taking the control action includes limiting a speed of the vehicle to a predetermined speed threshold, when it is determined that the closure of the vehicle is not closed via the latching mechanism.

Also in one embodiment, the method further includes: determining whether a responsive action has been taken in response to the control action; determining whether the closure is closed, after the responsive action; and terminating the control action if the closure is determined to be closed after the responsive action.

Also in one embodiment, the responsive action includes an opening of a driver door of the vehicle following the taking of the control action.

Also in one embodiment, the method further includes: determining whether a predetermined amount of time has lapsed following initiation of the control action; and automatically terminating the control action, after the predetermined amount of time.

Also in one embodiment, the method further includes: determining whether an override has been taken in response to the control action; and terminating the control action, if the override has been taken.

Also in one embodiment, the override includes an acknowledgement of the closure by an operator of the vehicle using a display device of the vehicle.

Also in one embodiment, the method further includes: providing a notification that the closure is open and that the control action is being taken, before the override has been taken; determining whether the closure is closed, after the override has been taken; terminating the notification in addition to terminating the control action, if the closure is determined to be closed after the override has been taken; and maintaining the notification, while terminating the control action, and providing a notification to service the latching mechanism or a sensor associated therewith, if the closure is determined to be open after the override has been taken.

In another exemplary embodiment, a system is provided. The system includes a sensor module and a processing module. The sensor module is configured to obtain sensor data via one or more sensors of a vehicle. The processing module coupled to the sensing module and configured to: determine whether a closure of the vehicle is closed via a latching mechanism, using the sensor data; and provide instructions, via a processor to a drive system of the vehicle, to take a control action to adjust movement of the vehicle when it is determined that the closure of the vehicle is not closed via the latching mechanism.

Also in one embodiment, the processing module is configured to provide instructions to prevent the vehicle from shifting out of a park gear when it is determined that the closure of the vehicle is not closed via the latching mechanism.

Also in one embodiment, the processing module is configured to provide instructions to limit a speed of the vehicle to a predetermined speed threshold when it is determined that the closure of the vehicle is not closed via the latching mechanism.

Also in one embodiment, the processing module is further configured to: determine whether a responsive action has been taken in response to the control action; determine whether the closure is closed, after the responsive action; and terminate the control action if the closure is determined to be closed after the responsive action.

In another exemplary embodiment, a vehicle is provided that includes a body, a propulsion system, a hood, a sensor, and a processor. The propulsion system is configured to generate movement of the body. The sensor is disposed onboard the vehicle and configured to provide sensor data pertaining to one or more components of the vehicle. The processor is disposed onboard the vehicle, coupled to the sensor, and is configured to: determine whether the hood is closed via a latching mechanism, using the sensor data; and provide instructions to a drive system of the vehicle, to take a control action to adjust movement of the vehicle when it is determined that the hood of the vehicle is not closed via the latching mechanism.

Also in one embodiment, the processor is configured to provide instructions to prevent the vehicle from shifting out of a park gear when it is determined that the hood of the vehicle is not closed via the latching mechanism.

Also in one embodiment, the processor is configured to provide instructions to limit a speed of the vehicle to a predetermined speed threshold when it is determined that the hood of the vehicle is not closed via the latching mechanism.

Also in one embodiment, the processor is further configured to: determine whether a responsive action has been taken in response to the control action; determine whether the hood is closed, after the responsive action; and terminate the control action if the hood is closed after the responsive action.

Also in one embodiment, the responsive action includes an opening or closing of a driver door of the vehicle.

Also in one embodiment, the processor is further configured to: determine whether an override has been taken in response to the control action; and terminate the control action, if the override has been taken.

Also in one embodiment, the processor is further configured to: provide instructions for a notification that the hood is open and that the control action is being taken, before the override has been taken; determine whether the hood is closed, after the override has been taken; terminate the notification in addition to terminating the control action, if the hood is determined to be closed after the override has been taken; and maintain the notification, while terminating the control action, if the hood is determined to be open after the override has been taken, or automatically after a predetermined amount of time has elapsed.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a hood, a latching mechanism for the hood, and a control system for controlling vehicle movement when the hood is not properly closed, in accordance with exemplary embodiments;

FIG. 2 is a block diagram of modules of the control system of FIG. 1, in accordance with exemplary embodiments; and

FIG. 3 is a flowchart of a process for controlling vehicle speed when the hood is not properly closed, and that can be implemented in connection with the vehicle and control system of FIGS. 1 and 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

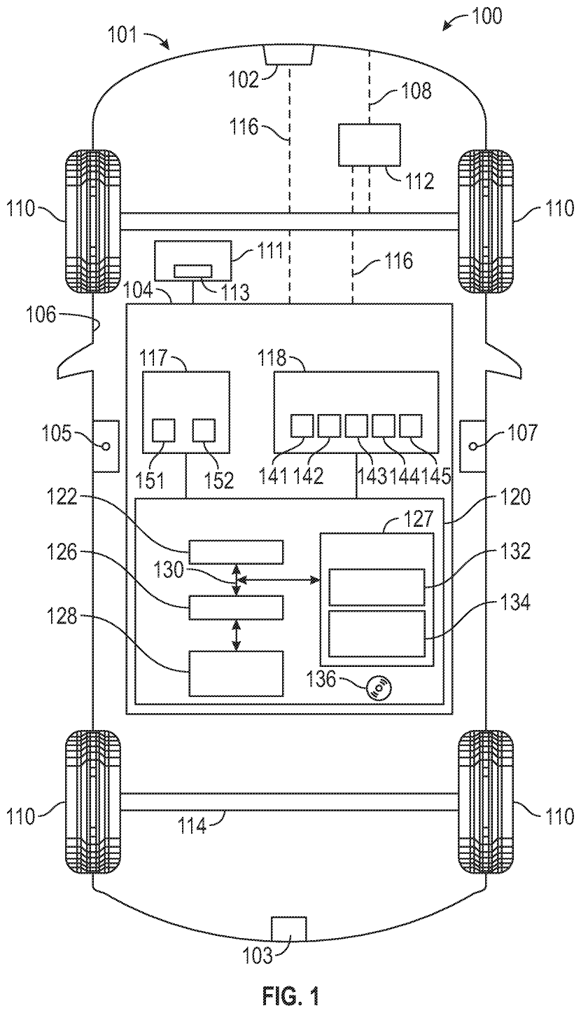

FIG. 1 illustrates a vehicle 100, according to an exemplary embodiment. As described in greater detail further below, the vehicle 100 includes a hood 101, a latching mechanism 102, and a control system 104. Also as described in greater detail below, the controller 120 adjusts (and in various embodiments, inhibits) movement of the vehicle 100 via one or more actions when the hood 101 (or one or more other closures of the vehicle 100) is not properly closed.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2 WD) (i.e., rear-wheel drive or front-wheel drive), four-wheel drive (4 WD) or all-wheel drive (AWD), and/or various other types of vehicles in certain embodiments.

The vehicle 100 includes a body 106 that is arranged on a chassis 108. The body 106 substantially encloses other components of the vehicle 100. The body 106 and the chassis 108 may jointly form a frame. The vehicle 100 also includes a plurality of wheels 110. The wheels 110 are each rotationally coupled to the chassis 108 near a respective corner of the body 106 to facilitate movement of the vehicle 100. In one embodiment, the vehicle 100 includes four wheels 110, although this may vary in other embodiments (for example for trucks and certain other vehicles). Also in various embodiments, the vehicle 100 includes a driver door 105 and one or more other doors 107 (e.g., passenger doors and/or cargo doors).

A drive system 112 is mounted on the chassis 108, and drives the wheels 110, for example via axles 114. The drive system 112 preferably comprises a propulsion system. In certain exemplary embodiments, the drive system 112 comprises an internal combustion engine and/or an electric motor/generator, coupled with a transmission thereof. In certain embodiments, the drive system 112 may vary, and/or two or more drive systems 112 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor. Also in various embodiments, the vehicle 100 includes a braking system 111 that includes a brake pedal 113 for engagement by an operator of the vehicle 100.

As depicted in FIG. 1, in certain embodiments, the hood 101 is part of the body 106 of the vehicle 100. In certain embodiments, the hood 101 comprises a hinged cover the engine of the vehicle 100 (e.g., in certain embodiments, near the front of the vehicle 100) that allows access to the engine compartment, for example for maintenance and repair. In certain other embodiments, the hood 101 may comprise a storage compartment, for example in an electric vehicle, or a mid-engine or rear-engine vehicle.

In various embodiments, the hood 101 is movable between an open position, in which the hood 101 extends away from the rest of the body 106 of the vehicle; and a closed position, in which the hood 101 rests against the rest of the body 106. In certain embodiments, the hood 101 moves between the open and closed positions via a pivot motion around a pivot point. Also in various embodiments, the latching mechanism 102 helps to secure the hood 101 in the closed position for the vehicle 100. In certain embodiments, the latching mechanism 102 may be engaged by a user outside the vehicle 100. In certain other embodiments, the latching mechanism 102 may be engaged by a user inside the vehicle in opening and closing the hood 101.

In various embodiments, the control system 104 is coupled to the latching mechanism 102 as well as to the drive system 112. In certain embodiments, the control system 104 detects whether the hood 101 is properly closed (e.g., properly secured in the closed position) via the latching mechanism 102 prior to movement of the vehicle 100, and inhibits movement of the vehicle 100 via one or more actions when the hood 101 is not properly closed. While the control system 104 (and accompanying systems and methods, described below) are discussed with respect to the hood 101 of the vehicle 100, it will be appreciated that in various embodiments the techniques described may also apply to one or more other closures of the vehicle 100, such as by way of example, a rear door 103 (e.g., a rear trunk or hatch), a driver door 105, one or more other doors 107 (e.g., passenger doors and/or cargo doors), and/or one or more other closures for the vehicle 100.

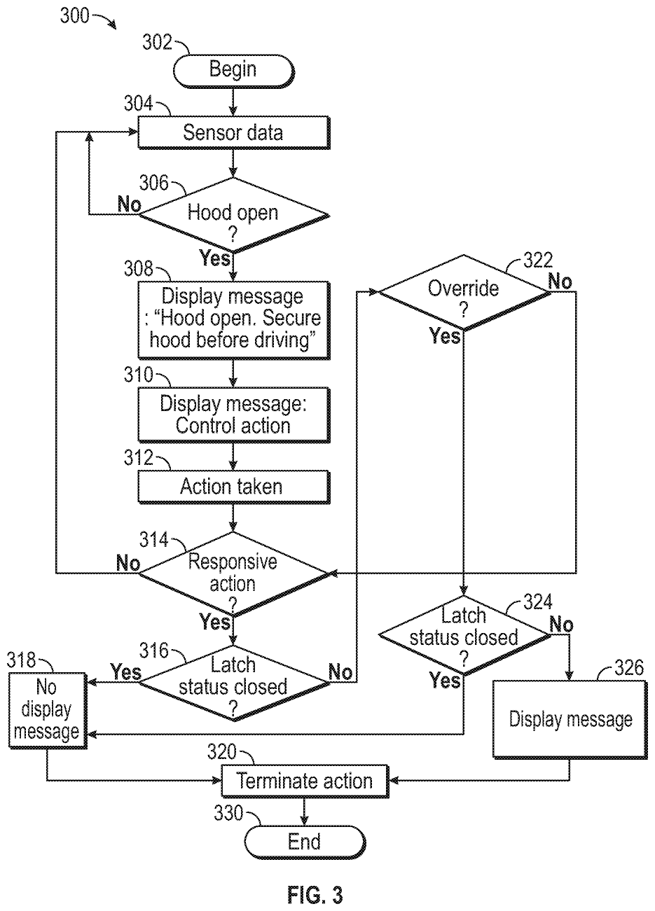

In certain embodiments, the control system 104 prevents a change in gear of the vehicle 100 when the hood 101 (or other closure) is not properly closed, for example for a particular amount of time and/or until an operator performs an acknowledgement or override action. In certain other embodiments, the control system 104 limits a speed of the vehicle 100 when the hood 101 is not properly closed. In various embodiments, the control system 104 provides instructions for the performance of such actions via the drive system 112, for example via the communications link 116 described above (e.g., via a vehicle CAN bus, a transceiver, and/or one or more other types of communications links). In certain embodiments, the control system 104 provides these functions in accordance with the process 300 described in greater detail further below in connection with FIG. 3.

In various embodiments, the control system 104 is disposed within the body 106 of the vehicle 100. In one embodiment, the control system 104 is mounted on the chassis 108. In certain embodiments, the control system 104 and/or one or more components thereof may be disposed outside the body 106, for example on a remote server, in the cloud, or in a remote smart phone or other device where image processing is performed remotely. In certain embodiments, the control system 104, or components thereof, are part of a body control module (BCM) of the vehicle 100 and/or a transmission control module (TCM) of the vehicle 100, among other possible modules and/or systems of the vehicle 100.

As depicted in FIG. 1, the control system 104 includes a display 117, a sensor array 118, and a controller 120. As noted above, in various embodiments, the control system 104 provides for actions to control movement of the vehicle 100 when the hood 101 is not securely closed via the latching mechanism 102.

In various embodiments, the display 117 provides information for an operator of the vehicle 100 as to whether the hood 101 (or other closure) is securely closed via the latching mechanism 102, and collects information from the operator as to whether to bypass any control actions relating thereto. In various embodiments, the display 117 may include an audio component 151, a visual component 152, or both. In various embodiments, when a determination is made that the hood 101 is not securely closed via the latching mechanism 102, then the display 117 provides one or more audio and/or visual notifications to this effect via the audio component 151 and/or visual component 152, respectively. Also in various embodiments, when the hood is not securely closed via the latching mechanism, the display 117 may also receive any override instructions from the operator (with respect to a desire to override any actions of the control system 104 in inhibiting movement of the vehicle 100) via the audio component 151 (e.g., via a microphone for receiving verbal instructions) and/or the visual component 152 (e.g., via a touch screen).

In various embodiments, the sensor array 118 provides sensor data to the controller 120. In various embodiments, the sensor array 118 includes one or more latch sensors 141 that are disposed within or in proximity to the latching mechanism 102 or to an edge of the hood 101, and that detect engagement of the latching mechanism 102 via the hood 101. Also in certain embodiments, the sensor array 118 further comprises one or more door sensors 142 that are disposed within or in proximity to the driver door 105 of the vehicle 100, and that detect when the driver door 105 is closed (e.g., via a latch of the driver door 105). In addition, in certain embodiments, the sensor array 118 further comprises one or more brake pedal sensors 143 that are disposed within or in proximity to the brake pedal 113 and that are configured to detect engagement thereof by an operator of the vehicle 100 (e.g., by measuring a force applied to the brake pedal 113 and/or travel by the brake pedal 113). In addition, in various embodiments, the sensor array 118 further comprises one or more display sensors 144 that are configured the receive any override instructions from the operator of the vehicle 100 (e.g., via a microphone of or coupled to the audio component 151 and/or a touch sensor of or coupled to the visual component 152 of the display 117). Also in certain embodiments, the sensor array 118 further comprises one or more parking brake sensors 145 that determine a position of a parking brake for the vehicle 100.

In various embodiments, the sensor array 118 provides the sensor data to the controller 120 via a communications link 116. In certain embodiments, the communications link 116 comprises a vehicle CAN bus. In certain other embodiments, the communications link 116 may comprise one or more other different buses and/or one or more wireless connections (e.g., using one or more transceivers), among other possible communications links.

In certain embodiments, the sensor array 118, and/or one or more components thereof, may be disposed within and/or be part of the control system 104. In other embodiments, the sensor array 118 may be coupled to the control system 104.

The controller 120 controls operation of the control system 104. Specifically, in various embodiments, the controller 120 controls and inhibits movement of the vehicle 100 via one or more actions when the hood 101 (or other closure) is not properly closed. In various embodiments, the controller 120 provides these and other functions in accordance with the steps of the process 300 discussed further below in connection with FIG. 3.

In one embodiment, the controller 120 is coupled to the sensor array 118. Also in one embodiment, the controller 120 is disposed within the control system 104, within the vehicle 100. In certain embodiments, the controller 120 (and/or components thereof, such as the processor 122 and/or other components) may be part of and/or disposed one or more other vehicle components. For example, in certain embodiments, the sensor array 118 may be part of a body control module (BCM) for the vehicle 100, and the controller 120 may be part of a transmission control module (TCM) for the vehicle 100; however, this may vary in other embodiments. In addition, in certain embodiments, the controller 120 may be placed outside the vehicle, such as in a remote server, in the cloud or on a remote smart device.

As depicted in FIG. 1, the controller 120 comprises a computer system. In certain embodiments, the controller 120 may also include the sensor array 118 and/or one or more other vehicle components. In addition, it will be appreciated that the controller 120 may otherwise differ from the embodiment depicted in FIG. 1. For example, the controller 120 may be coupled to or may otherwise utilize one or more remote computer systems and/or other control systems, for example as part of one or more of the above-identified vehicle devices and systems.

In the depicted embodiment, the computer system of the controller 120 includes a processor 122, a memory 124, an interface 126, a storage device 128, and a bus 130. The processor 122 performs the computation and control functions of the controller 120, and may comprise any type of processor or multiple processors, single integrated circuits such as a microprocessor, or any suitable number of integrated circuit devices and/or circuit boards working in cooperation to accomplish the functions of a processing unit. During operation, the processor 122 executes one or more programs 132 contained within the memory 127 and, as such, controls the general operation of the controller 120 and the computer system of the controller 120, generally in executing the processes described herein, such as the process 300 discussed further below in connection with FIG. 3.

The memory 124 can be any type of suitable memory. For example, the memory 124 may include various types of dynamic random access memory (DRAM) such as SDRAM, the various types of static RAM (SRAM), and the various types of non-volatile memory (PROM, EPROM, and flash). In certain examples, the memory 124 is located on and/or co-located on the same computer chip as the processor 122. In the depicted embodiment, the memory 124 stores the above-referenced program 132 along with one or more stored values 134 (e.g., including, in various embodiments, inputs provided by a user as to the hood 101 of the vehicle 100 and/or to override any control actions of the controller 120, and/or calibrations from when the vehicle 100 was manufactured, programmed, or serviced, and so on).

The bus 130 serves to transmit programs, data, status and other information or signals between the various components of the computer system of the controller 120. The interface 126 allows communications to the computer system of the controller 120, for example from a system driver and/or another computer system, and can be implemented using any suitable method and apparatus. In one embodiment, the interface 126 obtains the various data from the hood 101 and/or latching mechanism 102 and the sensor array 118. The interface 126 can include one or more network interfaces to communicate with other systems or components. The interface 126 may also include one or more network interfaces to communicate with technicians, and/or one or more storage interfaces to connect to storage apparatuses, such as the storage device 128.

The storage device 128 can be any suitable type of storage apparatus, including various different types of direct access storage and/or other memory devices. In one exemplary embodiment, the storage device 128 comprises a program product from which memory 124 can receive a program 132 that executes one or more embodiments of one or more processes of the present disclosure, such as the steps of the process 300 discussed further below in connection with FIG. 3. In another exemplary embodiment, the program product may be directly stored in and/or otherwise accessed by the memory 124 and/or a disk (e.g., disk 136), such as that referenced below.

The bus 130 can be any suitable physical or logical means of connecting computer systems and components. This includes, but is not limited to, direct hard-wired connections, fiber optics, infrared and wireless bus technologies. During operation, the program 132 is stored in the memory 124 and executed by the processor 122.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 122) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 120 may also otherwise differ from the embodiment depicted in FIG. 1, for example in that the computer system of the controller 120 may be coupled to or may otherwise utilize one or more remote computer systems and/or other control systems.

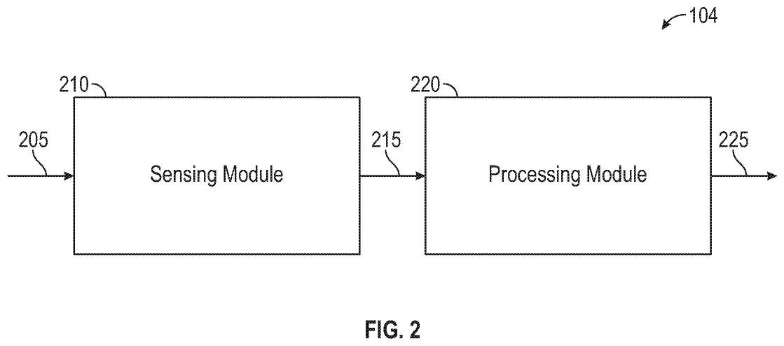

FIG. 2 provides a functional block diagram for modules of the control system 104 of FIG. 1, in accordance with exemplary embodiments. In various embodiments, each module includes and/or utilizes computer hardware, for example via one or more computer processors and memory. As depicted in FIG. 2, in various embodiments, the control system 104 generally includes a sensing module 210 and a processing module 220. In various embodiments, the sensing module 210 and processing module 220 are disposed onboard the vehicle 100. As can be appreciated, in certain embodiments, parts of the control system 104 may be disposed on a system remote from the vehicle 100 while other parts of the control system 104 may be disposed on the vehicle 100.

In various embodiments, the sensing module 210 obtains sensor data from the hood 101 (or other closure) and/or latching mechanism 102 of FIG. 1, as to whether the hood 101 (or other closure) of FIG. 1 is properly secured in a closed position via the latching mechanism 102. In various embodiments, the sensing module 210 obtains the sensor data via the sensor array 118 of FIG. 1 (e.g., via one or more latching sensors disposed within or coupled to the latching mechanism 102 or to the hood 101). In addition, in certain embodiments, the sensing module 210 also obtains sensor data as to any actions of an operator of the vehicle 100 in response to motion inhibiting vehicle control actions, such as an operator opening or closing the driver door 105 (e.g., as detected via a door sensor 142 of FIG. 1) and/or providing overriding instructions via the display 117 (e.g., as detected via a display sensor 144 of FIG. 1). In various embodiments, the sensing module 210 obtains the sensor data as inputs 205, as shown in FIG. 2.

Also in various embodiments, the sensing module 210 provides information pertaining to the sensor data (including as to whether the hood 101 or other closure is properly secured in a closed position via the latching mechanism 102, and also as to whether the operator of the vehicle has taken any responsive or override actions) as outputs 215 for use by the processing module 220, for example as discussed below.

In various embodiments, the processing module 220 utilizes the sensor data as inputs 215 for the processing module 220, and controls one or more vehicle actions as appropriate based on the sensor data. Specifically, in various embodiments, the processing module 220 provides instructions for taking one or more control actions for inhibiting motion for the vehicle 100 when it is determined using the sensor data that the hood 101 (or other closure) is not properly secured in a closed position via the latching mechanism, for example as described in greater detail below in connection with the process 300 of FIG. 3. In certain embodiments, such instructions are provided by the processing module 220 as outputs 225 depicted in FIG. 2 to a module associated with the drive system 112 of FIG. 1. Also in various embodiments, the processing module 220 also provides instructions to terminate such control actions in certain circumstances in which the operator has taken certain responsive actions (e.g., an override action), also as described in greater detail below in connection with the process 300 of FIG. 3.

FIG. 3 is a flowchart of a process 300 for controlling vehicle movement when it is determined that a hood (or other closure) of the vehicle is not properly closed, in accordance with exemplary embodiments. The process 300 can be implemented in connection with the vehicle 100 and control system 104 of FIGS. 1 and 2, in accordance with exemplary embodiments. Similar to the discussion above, while the process 300 is discussed with respect to the hood 101 of the vehicle 100, it will be appreciated that in various embodiments the methods and techniques described may also apply to one or more other closures of the vehicle 100, such as by way of example, a rear door 103 (e.g., a rear trunk or hatch), a driver door 105, one or more other doors 107 (e.g., passenger doors and/or cargo doors), and/or one or more other closures for the vehicle 100.

As depicted in FIG. 3, the process begins at step 302. In one embodiment, the process 300 begins when a vehicle drive or ignition cycle begins, for example when a driver approaches or enters the vehicle 100, or when the driver closes the driver door 105 of the vehicle when entering the vehicle, or when the driver turns on the vehicle and/or an ignition therefor (e.g. by turning a key, engaging a keyfob or start button, and so on). In one embodiment, the steps of the process 300 are performed continuously during operation of the vehicle.

Sensor data is received at 304. In various embodiments, the sensor data is received from the sensor array 118. In certain embodiments, sensor data is continually collected throughout the process 300 from the latch sensors 141, door sensor 142, brake pedal sensors 143, and display sensors 144 regarding latching of the hood 101 (or other closure) with the latching mechanism 102, opening and closing of the driver door 105, engagement of the brake pedal 113, sensor data from one or more parking brake sensors 145 as to a position of a parking brake of the vehicle 100, and/or inputs provided via the display 117, respectively.

A determination is made at 306 as to whether the hood 101 is open. Specifically, in various embodiments, the hood 101 (or other closure) is determined to be open when the hood 101 (or other closure) is not securely closed via engagement of the latching mechanism 102 of FIG. 1. In certain embodiments, this determination is made via the processing module 220 of FIG. 2 and the processor 122 of FIG. 1 using the sensor data of 304. In certain other embodiments, the open status of the hood 101 may be detected directly via the latch sensor 141 as part of the sensor data, and/or may be determined via the latch sensor 141 (e.g., via a smart sensor or built-in processor).

In various embodiments, if the hood 101 (or other closure) is not open, then the process returns to 304. Steps 304 and 306 thereafter continue until a determination is made in a subsequent iteration of step 306 that the hood 101 is open.

Once a determination is made in an iteration of 306 that the hood 101 (or other closure) is open, then in various embodiments one or more notifications are made at 308 indicating that the hood 101 (or other closure) is open. In certain embodiments, the processing module 220 of FIG. 2 and/or the processor 122 of FIG. 1 provide instructions for the display 117 of FIG. 1 to provide one or more visual and/or audio messages indicating that the hood 101 is open. For example, one such message may state: “Hood Open. Secure Hood Before Driving” (although the exact words may vary in different embodiments).

In addition, in certain embodiments, an additional message may also be provided at 310 with respect to a control action that is being taken due to the hood 101 (or other closure) being open. In various embodiments, the control action inhibits movement of the vehicle 100. In certain embodiments, a notification is provided that the vehicle 100 may not be shifted out of a “park” gear until one or more conditions are satisfied. In certain other embodiments, a notification is provided that a speed of the vehicle 100 will be limited to a predetermined threshold speed. In various embodiments, the additional message of 310 is provided via the display 117 of FIG. 1 (in audio and/or visual format) based on instructions provided by the processing module 220 of FIG. 2 and/or the processor 122 of FIG. 1. In certain embodiments, the message(s) of 308, 310 may comprise a single message.

In addition, one or more control actions are implemented at 312. In various embodiments, one or more control actions to inhibit movement of the vehicle 100 are implemented via instructions provided by the processing module 220 of FIG. 2 and/or the processor 122 of FIG. 1 to the drive system 112 of FIG. 1. In certain embodiments, the vehicle 100 is prevented from shifting out of a “park” gear (e.g., into a “drive” gear), at least until one or more predetermined conditions are met (e.g., a responsive action, an operator override). In certain embodiments, the vehicle 100 is prevented from travelling faster than a predetermined speed. In one embodiment, the predetermined speed is equal to thirty miles per hour (30 mph); however, this may vary in other embodiments.

In certain embodiments, a determination is made at 314 as to whether an operator of the vehicle 100 has taken a responsive action. In various embodiments, a determination is made as to whether an operator has taken a responsive action in response to the notification(s) of 308, 312 and/or in response to the control action(s) of step 312. In certain embodiments, the responsive action comprises an opening of the driver door 105 after initiation of the message(s) of 308, 310 and/or the control action(s) of 312. In certain other embodiments, the responsive action comprises another action by an operator to close, check on, and/or acknowledge the hood 101 (e.g., engaging a switch or device to close the hood 101, providing an acknowledgement via a touchscreen or microphone of the display 117, and so on). In various embodiments, such determinations are made by the processing module 220 of FIG. 2 and the processor 122 of FIG. 1 using sensor data of an iteration of step 304 after the notification(s) of step 308, 310 and/or the control action(s) of step 312 have been initiated.

In various embodiments, if it is determined at 314 that a responsive action has not been taken (e.g., if the operator has not opened the driver door 105, has not engaged a switch or device to close the hood 101 (or other closure), has not provided a responsive message via the display 117, and so on), then the process returns to step 304, as sensor data continues to be collected. Steps 304-314 repeat until a determination is made in an iteration of step 314 that such a responsive action has been taken.

Once it is determined in an iteration of step 314 that a responsive action has been taken (e.g., that the driver door 105 has been opened, the operator has engaged a switch or device to close the hood 101 (or other closure), and/or the operator has provided a responsive message via the display 117, or the like), then a determination is made at 316 as to whether the hood 101 is now closed. In various embodiments, this determination is similar or identical to the determination made at 306 above.

If it is determined at 316 that the hood 101 (or other closure) is now closed, then, at 318, the message(s) of steps 308, 310 are no longer displayed. In various embodiments, during 318, the processor 122 of FIG. 1 provides instructions for the display 117 of FIG. 1 to no longer display the message(s) of 308, 310. The process then proceeds to step 320, described directly below.

In various embodiments, the control action(s) are terminated at 320. Specifically, in various embodiments, the control actions of 312 are now terminated, now that the hood 101 (or other closure) is determined to be closed. In certain embodiments, the processor 122 of FIG. 1 provides instructions to the drive system 112 of FIG. 1 to no longer inhibit movement of the vehicle 100. Accordingly, if the vehicle 100 was prohibited from shifting out of a “park” gear, the vehicle 100 will not be permitted to shift out of the “park” gear (e.g., into a “drive” gear) once the operator engages the brake pedal 113 and requests a shift in gear (e.g., engaging a gear lever, button, or the like, as detected by sensors of the sensor array 118 of FIG. 1). Likewise, if a speed of the vehicle 100 was limited, then this speed limit will no longer be in effect, and so on. In various embodiments, the process then terminates at 330.

Conversely, if it is determined at 316 that the hood 101 (or other closure) is not closed, then the process proceeds instead to 322. During step 322, a determination is made as to whether an override has occurred (e.g., as part of the responsive action of step 314) with respect to the control action(s) of step 312.

In certain embodiments, such an override would be deemed in 322 to have taken place if the driver door 105 has been opened for at least a predetermined amount of time following initiation of the notification(s) of 308, 310 and/or the control action(s) of 312. In one such embodiment, such a predetermined amount of time is equal to ten seconds; however, that may vary in other embodiments.

In certain other embodiments, such an override would be deemed in 322 to have taken place if the driver door 105 was opened for at least a first predetermined amount of time, or if the driver door 105 was opened and closed at least two times within a second amount of time, or both. For example, in one such embodiment, such an override would be deemed to have taken place if the door had been closed for at least three seconds (as the first predetermined amount of time) after the operator had entered the vehicle 100, or if the door had been opened and closed twice within one minute (as the second predetermined amount of time) in response to the initiation of the notification(s) of 308, 310 and/or the control action(s) of 312. It will be appreciated that the first and second predetermined amounts of time may vary in different embodiments.

In certain other embodiments, such an override would be deemed in 322 to have taken place if an operator of the vehicle 100 affirmatively acknowledges one or more of the message(s) of 308, 310. For example, in certain embodiments, the operator may engage a touchscreen or microphone of the display 117 of FIG. 1 with an acknowledgement of the message(s) and/or a request to override the control action(s). The operator may do so, for example, if the operator has been able to double check that the hood 101 is in fact closed, for example via a visual inspection of the hood 101 and/or checking a secondary securement mechanism for the hood 101. For example, in situations in which (A) the hood 101 is latched but a latch sensor 141 does not recognize this due to a sensor error; or (B) the hood 101 is secured via a secondary mechanism besides the latching mechanism 102, the operator may opt to override the control action(s) and operate the vehicle 100.

In yet other embodiments, an override may comprise one or more other actions of an operator of the vehicle 100, and/or in some cases may be satisfied automatically by the passage of a predetermined amount of time via a timer. For example, in certain embodiments, an override may comprise one or more other actions of an operator opening one or more doors of the vehicle 100. Also in certain embodiments, a timer may be utilized, for example such that one or more control action(s) of step 312 may be in effect only for a predetermined amount of time, and may automatically be deactivated after the passage of the predetermined amount of time.

In yet another embodiment, when speed limiting is one of the employed methods for the control action, an override may be determined to have occurred when a driver or operator performs a deliberate full throttle activation for a predetermined amount of time. For example, in certain embodiments, such an action can be determined by looking at parameters such as whether a minimum of eighty percent (80%) throttle has been maintained for at least five hundred milliseconds (500 msec), although the specific percentages, times, and values may vary in different embodiments.

If it is determined at 322 that an override has occurred for the control action(s) 312, then then the process proceeds to step 324. During step 324, a determination is made as to whether the hood 101 (or other closure) is now closed. In various embodiments, this determination is the same or similar as steps 306, 316. In certain embodiments, the acknowledgment(s) may be provided remote from the vehicle (e.g., using a cell phone application or from a remote server or “back office”), for example in the case of semi or fully autonomous vehicles, wherein the controller (e.g., owner or remote operator) has been able to verify through some other means that the hood is secured enough to move the vehicle). Also in certain embodiments, one or more sensing means (e.g., cameras on the vehicle or a hood angle sensor, additional switches in the latch mechanism, and so on) may also be used to verify that the hood 101 is at least secured in the secondary position, or fully closed but likely a sensor fault in the latch.

In various embodiments, if it is determined at step 324 that the hood 101 (or other closure) is now closed, then the process proceeds to the above-described step 318, in which the message(s) are no longer displayed. The process then proceeds to the above-described step 320, in which the vehicle 100 movement inhibiting action(s) are terminated. The process then terminates at the above-described step 330.

Conversely, in various embodiments, if it is determined at step 324 that the hood 101 (or other closure) is not closed, then the process proceeds instead to step 326. During step 326, a message may be displayed instructing the operator to service the hood latch (or hood latch sensor), and the message(s) of steps 308, 310 may continue to be provided, for example because the hood 101 has not been determined to be closed. In various embodiments, this is performed via instructions provided by the processor 122 of FIG. 1 to the display 117 of FIG. 1. Also in various embodiments, the process then proceeds to the above-referenced step 320, in which the control actions are terminated (e.g., because the control actions have now been overridden). The process then terminates at the above-described step 330.

Accordingly, the process 300 of FIG. 3 provides for notifications as well as control actions to inhibit vehicle movement when it is determined that the hood (or other closure) of the vehicle is not securely closed via a latching mechanism. In certain embodiments, the vehicle is prohibited from being switched from a “park” gear. In certain other embodiments, a speed of the vehicle is limited. Also in various embodiments, the control actions may be overridden by an operator of the vehicle as appropriate, and in certain embodiments after the passage of a predetermined amount of time.

Accordingly, methods, systems, and vehicles are provided for controlling movement of a vehicle when it is determined that the hood (or other closure) of the vehicle is not securely closed via a latching mechanism. The methods, systems, and vehicles provide for appropriate safeguards and controls in the event the hood is open, as well as override options as appropriate to avoid unnecessary restrictions when the hood may indeed be closed and/or vehicle movement is required.

It will be appreciated that the systems, vehicles, and methods may vary from those depicted in the Figures and described herein. For example, the vehicle 100, the control system 104, and/or components thereof of FIGS. 1 and 2 may vary in different embodiments. It will similarly be appreciated that the steps of the process 300 may differ from those depicted in FIG. 3, and/or that various steps of the process 300 may occur concurrently and/or in a different order than that depicted in FIG. 3.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method comprising:
obtaining sensor data as to whether a hood of a vehicle is closed via a latching mechanism, via one or more sensors of the vehicle, including a latch sensor in proximity to the latching mechanism;
and
taking a control action, based on instructions provided by a processor of the vehicle to a drive system of the vehicle, to adjust movement of the vehicle when it is determined that the hood of the vehicle is not closed via the latching mechanism.

2. The method of claim 1, wherein the step of taking the control action comprises:
preventing the vehicle from shifting out of a park gear, when it is determined that the hood of the vehicle is not closed via the latching mechanism.

3. The method of claim 1, wherein the step of taking the control action comprises:
limiting a speed of the vehicle to a predetermined speed threshold, when it is determined that the hood of the vehicle is not closed via the latching mechanism.

4. The method of claim 1, further comprising:
determining whether an opening of a driver door of the vehicle for at least a first predetermined amount of time sufficient for an occupant of the vehicle to determine whether the hood is closed has been taken in response to a notification of the control action after the driver door was initially closed;
and
automatically terminating the control action, after the opening of the driver door has occurred for at least the first predetermined amount of time following the notification of the control action after the driver door was initially closed.

5. The method of claim 4, wherein:
the step of determining of the opening of the driver door comprises determining whether opening of the driver door of the vehicle has occurred at least twice within a second predetermined amount of time following the notification of the control action after the driver door was initially closed.

6. The method of claim 4, wherein the predetermined amount of time first predetermined amount of time is equal to approximately ten seconds and the second predetermined amount of time is equal to approximately one minute.

7. The method of claim 1, further comprising:
determining whether an override has been taken in response to the control action, wherein the override comprises an acknowledgement of closure of the hood by an operator of the vehicle; and
terminating the control action, if the override has been taken.

8.-9. (canceled)

10. A system comprising:
a sensor module configured to obtain sensor data via one or more sensors of a vehicle, including a latch sensor; and
a processing module coupled to the sensing module and configured to, via a processor:
determine whether a hood of the vehicle is closed via a latching mechanism, using the sensor data; and
provide instructions, via a processor to a drive system of the vehicle, to take a control action to adjust movement of the vehicle when it is determined that the hood of the vehicle is not closed via the latching mechanism.

11. The system of claim 10, wherein the processing module is configured to provide instructions to prevent the vehicle from shifting out of a park gear when it is determined that the hood of the vehicle is not closed via the latching mechanism.

12. The system of claim 10, wherein the processing module is configured to provide instructions to limit a speed of the vehicle to a predetermined speed threshold when it is determined that the hood of the vehicle is not closed via the latching mechanism.

13. The system of claim 10, wherein the processing module is further configured to:
determine whether an opening of a driver door of the vehicle for at least a predetermined amount of time sufficient for an occupant of the vehicle to determine whether the hood is closed has been taken in response to a notification of the control action after the driver door was initially closed;
and
automatically terminate the control action, after the opening of the driver door has occurred for at least the predetermined amount of time following the notification of the control action after the driver door was initially closed.

14. A vehicle comprising:
a body;
a propulsion system configured to generate movement of the body;
a hood;
one or more sensors, including a latch sensor, disposed onboard the vehicle and configured to provide sensor data pertaining to whether a hood of the vehicle is closed via a latching mechanism; and
a processor disposed onboard the vehicle, coupled to the sensor, and configured to:
determine whether the hood is closed via the latching mechanism, using the sensor data; and
provide instructions to a drive system of the vehicle, to take a control action to adjust movement of the vehicle when it is determined that the hood of the vehicle is not closed via the latching mechanism.

15. The vehicle of claim 14, wherein the processor is configured to provide instructions to prevent the vehicle from shifting out of a park gear when it is determined that the hood of the vehicle is not closed via the latching mechanism.

16. The vehicle of claim 14, wherein the processor is configured to provide instructions to limit a speed of the vehicle to a predetermined speed threshold when it is determined that the hood of the vehicle is not closed via the latching mechanism.

17. The vehicle of claim 14, wherein the processor is further configured to:
determine whether an opening of a driver door of the vehicle for at least a first predetermined amount of time sufficient for an occupant of the vehicle to determine whether the hood is closed has been taken in response to a notification of the control action after the driver door was initially closed;
and
automatically terminate the control action, after the opening of the driver door has occurred for at least the first predetermined amount of time following the notification of the control action after the driver door was initially closed.

18. The vehicle of claim 17, wherein the processor is further configured to:
determine the opening of the driver door of the vehicle at least twice within a second predetermined amount of time following a notification of the control action after the driver door was initially closed; and
automatically terminate the control action after the opening of the driver door at least twice following the notification of the control action after the driver door was initially closed.

19. The vehicle of claim 14, wherein the processor is further configured to:
determine whether an override has been taken in response to the control action; and
terminate the control action, if the override has been taken.

20. (canceled)

21. The vehicle of claim 18, wherein:
the first predetermined amount of time is equal to approximately ten seconds; and
the second predetermined amount of time is equal to approximately one minute.

22. The vehicle of claim 17, wherein the processor is further configured to:
determine the opening of driver door of the vehicle as occurring following a notification of the control action after the driver door was initially closed, the opening occurring at least a third predetermined amount of time after a passenger has entered the vehicle; and
automatically terminate the control action after the opening of driver door of the vehicle as occurring following a notification of the control action after the driver door was initially closed, the opening occurring at least a third predetermined amount of time after a passenger has entered the vehicle.

23. The vehicle of claim 22, wherein:
the third predetermined amount of time is equal to approximately three seconds.
